(19) United States
(12) Patent Application Publication
(10) Pub. No.: US 2004/0255028 A1
(43) Pub. Date: Dec. 16, 2004

(54) Functional decomposition of a router to support virtual private network (VPN) services

(75) Inventors: Thomas P. Chu, Englishtown, NJ (US); Francis Robert Magee JR., Lincroft, NJ (US); Steven Howard Richman, Marlboro, NJ (US); Bhadrayu J. Trivedi, Morganville, NJ (US)

Correspondence Address: MOSER, PATTERSON & SHERIDAN L.L.P., 595 SHREWSBURY AVE, STE 100, FIRST FLOOR, SHREWSBURY, NJ, 07702, US

(73) Assignee: LUCENT TECHNOLOGIES INC.

(21) Appl. No.: 10/449,549

(22) Filed: May 30, 2003

(51) Int. Cl. G06F 15/16; G06F 15/173

(52) U.S. Cl. 709/227; 709/238

(57) ABSTRACT

A method and apparatus for providing virtual private network (VPN) connectivity between at least two customer sites. Each of a plurality of PE routers includes at least one access module adapted for connectivity to at least one customer site. The access modules are generated automatically for each PE router associated with a VPN, wherein customer sites, which are associated with said VPN and have an identical export route target (RT) value and import RT value, are connected to a common access module. Otherwise, customer sites associated with the PE router that do not have identical export and import RT values are coupled to their own respective access modules at the PE router. Each access module generates an ingress-forwarding table for routing packetized information between the at least two customer sites.

### FIELD OF INVENTION

The present invention relates to virtual private network (VPN) services. More specifically, the present invention relates to routers for providing connectivity for customer sites subscribing to VPN services.

### DESCRIPTION OF THE BACKGROUND ART

Two common approaches used to implement a service provider (SP) based IP-Virtual Private Network (IP-VPN) are Multi-Protocol Label Switching (MPLS) and “virtual routers” (VR). The MPLS approach is articulated in an Internet protocol proposal Request for Comment 2547 (RFC 2547) entitled “BGP/MPLS VPN'S”, E. Rosen and Y. Rekhter (and its 2^{nd} version, RFC2547bis), which is rapidly gaining acceptance in the industry.

A basic requirement for a VPN service is that each IP VPN subscriber must be able to use its own private IP addressing scheme. Therefore, each service provider router (i.e.,“provider edge (PE)” router) needs to be able to route IP packets differently for different incoming data streams. This may require a different decision process for each data stream. Under the RFC 2547 architecture a single routing/forwarding table with “context” is created for each VPN site.

Routing tables are stored within each PE router and routes learned from an attached customer network router (i.e.,“customer edge (CE)” router) are populated in a VPN Routing Forwarding (VRF) table. All customer sites that share the same routing information and connected to the same location may be placed in a common VRF table, which is identified by a Route Distinguisher (RD). However, such sites are automatically able to communicate with other. RD assignment is the responsibility of the SP, and creating such VRF tables manually is cost prohibitive and not scaleable.

Further, assigning two sites with the same routing characteristics to the same VRF table may not be desirable in some instances. Specifically, if the two sites having the same characteristics are assigned to the same routing table, the two sites will automatically send packets to each other, which may be undesirable in some VPN configurations. To overcome the automatic sending of packets to sites assigned the same VRF table, a different VRF table may be assigned to each site. However, to do so would require more resources, which increases the operational costs and reduces the efficiency of the network.

### SUMMARY OF THE INVENTION

The disadvantages heretofore associated with the prior art are overcome by a novel method and apparatus for generating ingress VPN Routing Forwarding (VRF) tables based on routing targets (RTs), as opposed to route distinguisher (RD) assignments, as provided under the RFC 2547 specification. As such, in instances where two sites are assigned to the same VRF table, the packets are no longer automatically sent between the sites, unless their respective import RTs match.

In particular, for each VPN at a customer site, the associated PE router is made up of hardware and/or software access modules that connect between a customer site and the PE router. The access modules are automatically generated at each PE router for each VPN. Specifically, customer sites associated with a particular VPN having an identical export route target (RT) values and import RT values are connected to a common access module, while customer sites associated with the PE router that do not have identical export and import RT values are coupled to their own respective access modules at the PE router. The PE routers advertise their RT values from their respective export RT lists to their peer routers.

Each access module has an associated ingress-forwarding table, which identifies other customer sites associated with the VPN, such that packets may be transported between the sites. That is, from a customer edge (CE) router at a local customer site to its local peer PE router, and then to either another customer site also connected to the same local PE router, or to a customer site that is coupled to a remote PE router.

In one embodiment where packets are sent to other PE routers, the advertised RT values from the peer PE routers are compared to an export RT list associated with the access module. In an instance where any RT values in the route advertisement of the peer PE routers having an identical RT values associated with the export RT list of the access module, an entry is created in the ingress-forwarding table of the access module.

In particular, the PE router will compare the import RT list and the export RT lists of an access module. If there is a common value between the two lists, locations connecting to the access module can send packets to each other. If there is no commonality of values between the two lists, the access module will not allow communications between the customer sites connecting to the access module, thereby overcoming the problem of two sites automatically sending packets to each other when both are assigned to the same VRF table.

In a second embodiment, packets may be sent from a first access module in a local PE router to a second access module in the same PE router. Specifically, the PE router compares the export RT lists of one access module with the import RT list of another access module (and vice versa) to determine whether one access module can forward packets to another access module in the same PE router.

In a third embodiment, packets may be sent to another customer site connected to the same access module. Specifically, the PE router compares the import and export lists of the common access module to determine whether packets can be forwarded to another from one customer site to another customer site connected to the common access module in the PE router. In any of the embodiments described above, the PE router advantageously generates the route distinguisher (RD) parameter, thereby relieving the user of the burden of assigning it to each customer location.

In accordance with an aspect of the invention, the same protocol for exchanging VPN information (BGP-MP), and the same encapsulation scheme for user data packets (double MPLS labels) as is used in RFC 2547, may be employed. Advantageously, doing so will ensure interoperability with existing RFC 2547 compliant routers. This is accomplished by using. In a network consisting entirely of routers using this invention, other functional equivalent protocol and encapsulation techniques may be used.

### BRIEF DESCRIPTION OF THE DRAWINGS

The teachings of the present invention can be readily understood by considering the following detailed description in conjunction with the accompanying drawings, in which:

FIG. 1 depicts a high-level block diagram of an exemplary virtual private network (VPN) network suitable for implementing the present invention;

FIG. 2 depicts a schematic diagram for transferring packets across the VPN network of FIG. 1;

FIG. 3 depicts a schematic diagram of an exemplary VPN network 300 of the present invention;

FIG. 4 depicts a block diagram of an exemplary router of the present invention suitable for use in the exemplary network of FIG. 3;

FIG. 5 depicts a schematic diagram of an exemplary VPN network having two full VPN components;

FIG. 6 depicts a schematic diagram illustrating physical connectivity of the network of FIG. 5;

FIG. 7 depicts a high-level block diagram illustrating asset module allocation to support the VPN network of FIGS. 5 and 6;

FIGS. 8A and 8b depict a schematic diagram of an exemplary hub-and-spoke network 800 and connectivity under the present invention;

FIG. 9 depicts a schematic diagram of a second embodiment of a VPN network;

FIG. 10 depicts a schematic diagram illustrating physical connectivity of the network of FIG. 9;

FIG. 11 depicts a high-level block diagram illustrating asset module allocation to support the VPN network of FIGS. 9 and 10;

FIG. 12 depicts a flow diagram of a method 1200 of implementing the VPN of the present invention; and

FIGS. 13A and 13 B together depict a flow diagram of a method 1200 of modifying sites in a VPN network.

### To facilitate understanding, identical reference numerals have been used, where possible, to designate identical elements that are common to the figures.

### DETAILED DESCRIPTION OF THE INVENTION

The present invention provides a method for implementing capabilities such as those contemplated by RFC 2547 within a router. RFC 2547 provides a method by which a Service Provider with an IP backbone may provide VPNs (Virtual Private Networks) for its customers. MPLS (Multiprotocol Label Switching) is used for forwarding packets over the backbone, and BGP (Border Gateway Protocol) is used for distributing routes over the backbone. The RFC 2547 and 2547bis (2^{nd} version) documents are hereby incorporated by reference herein in their entireties.

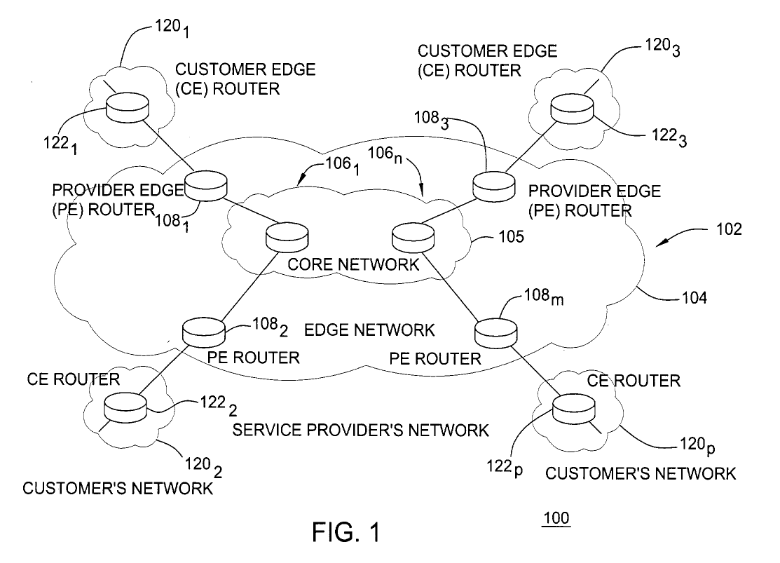

FIG. 1 depicts a high-level block diagram of an exemplary network 100 suitable for implementing the present invention. The network 100 comprises a service provider network 102 and a plurality of customer networks 120₁ through 120ₚ (collectively customer networks 120). The service provider network 102 comprises a core network 105 formed by a plurality of core routers and switches 106₁ through 106ₙ (collectively core routers 106), and an edge network 104 formed by a plurality of “provider edge” (PE) routers 108₁ through 108ₘ (collectively PE routers 108). The PE routers 108 are connected to the core routers 106. Further, it is noted that subscripts “m”, “n”, and “p” are integers greater than one.

The customer networks 120 may be intranet and/or extranet types of networks, each having a “customer edge” (CE) router 122, which is connected to the provider edge routers 108. For example, in FIG. 1 the CE router 122, is connected to the PE router 108₁, CE router 122₂ is connected to PE router 108₂, and so forth. It is noted that multiple CE routers 122 belonging to the same or different VPNs may be connected to a single PE router 108.

Under the RFC 2547 (i.e., MPLS-based techniques) architecture, as well as the present invention, all VPN functions are implemented in the PE routers 108. The core routers (i.e., P-routers) 106 are operable to forward MPLS “packets,” but they are not aware that the packets belong to a VPN. Similarly the CE routers 122 behave as if they are connected to ordinary routers, and are not aware that the PE routers 108 are RFC 2547 compliant.

Furthermore, a customer site is connected to a PE router 108 through a CE router 122 and the connection (access method) is identified via a layer 1 or a layer 2 identifier, which may represent a physical interface ID; a virtual path/virtual circuit identifier of an Asynchronous Transfer Mode (ATM) interface; a data link connection identifier (DLCI) of a frame relay interface; a virtual local area network identifier of an Ethernet serial link interface; and/or the MPLS label of a MPLS interface.

Two sites have IP connectivity over a common backbone (core network) 102 only if there is some VPN that contains them both. If two sites do not belong to a common VPN, then there is no connectivity over that backbone between the sites. In an instance where all the sites in a VPN are owned by the same enterprise, the VPN is a corporate “intranet.” Alternatively, if the various sites in a VPN are owned by different enterprises, the VPN is an “extranet.” A site may be included in more than one VPN, for example, in an intranet and several extranets. Both intranets and extranets are regarded as VPNs, and the term VPN is not used herein to distinguish between intranets and extranets.

The backbone (i.e., core network and PE routers) is typically owned and operated by one or more Service Providers (SPs), and the owners of the sites are typically the “customers” of the SPs. The policies that determine whether a particular collection of sites form a VPN are those dictated by the customers.

Various techniques discussed herein allow the implementation of a wide range of policies. For example, within a given VPN, every site may have a direct route to every other site ( “full mesh”), or certain pairs of sites may be restricted from having direct routes to each other ( “partial mesh”).

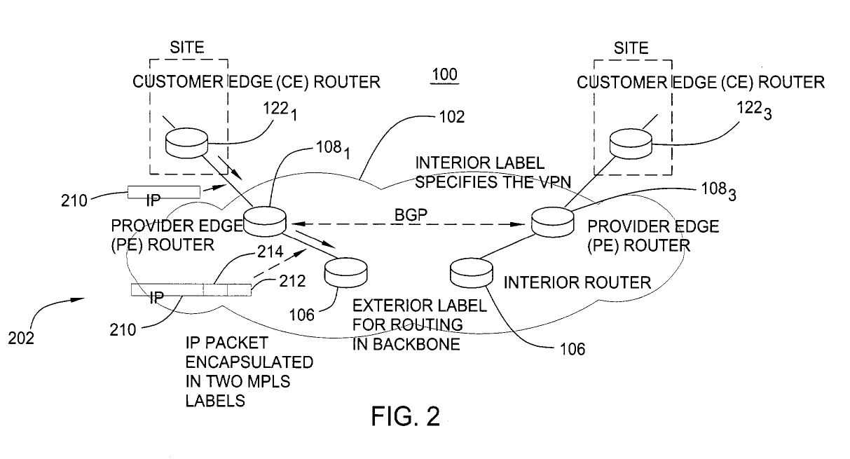

FIG. 2 depicts a schematic diagram illustrating transferring packets across the VPN network of FIG. 1. FIG. 2 is an exploded view of a portion of FIG. 1 illustratively depicting the CE router 122₁ connected to the PE router 108₁, as well as the CE router 122₃ connected to the PE router 108₃ via the core routers 106 of the core network 105. IP packets 210 from the customers are transferred over the network 102 encapsulated in MPLS frames 202 comprising an exterior label 212 and interior label 214. The exterior label 212 is used to route a packet 210 from the ingress PE (e.g., PE 108₁) to the egress PE (e.g., PE 108₃) across the network 102. The exterior label 212 is examined by all of the routers, hop by hop, across the network 102. The egress router (e.g., PE 108₃) uses the interior label 214 to determine the egress interface (e.g., destination customer edge (CE) device).

One reason for the encapsulation of IP packet 210 within MPLS is that each VPN uses its own IP address space. The IP address assignments may potentially conflict with each other, as well the service provider's own IP address assignment. The exterior MPLS label 212 serves as an insulator between the customer's IP address space and service provider IP addressing space for the routing of the packet across the SP's network. The exterior label 212 is determined when the MPLS Label Switched Paths (LSP) are set up between the PE routers 108. The interior label 214 is specified by the egress PE, one for each interface, in the route advertisement to other PE routers.

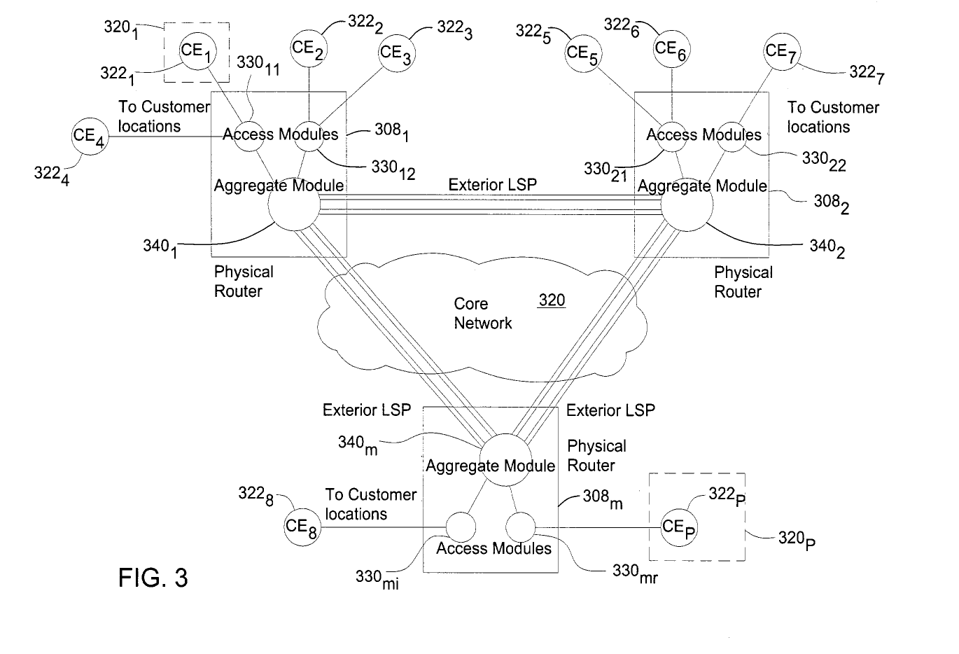

FIG. 3 depicts a schematic diagram of an exemplary VPN network of the present invention. In particular, the VPN network 300 comprises a plurality of provider edge (PE) routers 308₁ through 308ₘ (collectively PE routers 308) coupled to a core network 302. The core network 102 comprises a plurality of core routers and switches (not shown) that provide connectivity between the PE routers 308. Further, each PE router 308 is coupled to one or more customer edge (CE) devices 322₁ through 322ₚ (collectively CE devices 322) respectively at various customer sites 320₁ through 320ₚ (collectively sites 320). The core network 308 may be a public network, such as the Internet, while the customers may be corporate or enterprise entities having a multitude of end users at various sites utilizing the VPN-IP network 302.

More specifically, at each site, there are one or more Customer Edge (CE) devices 322, each of which is attached via a data link (e.g., PPP, ATM, Ethernet, Frame Relay, GRE tunnel, etc.) to one or more Provider Edge (PE) routers 308. If a particular site has a single host, that host may be the CE device. If a particular site has a single subnet, that the CE device may be a switch. Typically, the CE device 322 is a router, which is commonly termed a CE router. A CE device 322 is always regarded as being in a single logical site 320 (although a physical customer site may consist of multiple “virtual logical sites”). However, a site 320 may belong to multiple VPNs.

A PE router 308 is attached to a particular VPN if it is attached to a CE device 322 that is in that VPN. Similarly, a PE router 308 is attached to a particular site if it is attached to a CE device 322 that is in that site. When the CE device 322 is a router, it is a routing peer of the PE(s) to which it is attached, but is not a routing peer to CE routers 322 at other sites 320. CE routers 322 at different sites 320 do not directly exchange routing information with each other. In fact, they do not even need to know of each other at all (except in the case where this is necessary for security purposes). As a consequence, very large VPNs (i.e., VPNs with a very large number of sites) are easily supported, such that the routing strategy for each individual site is greatly simplified.

Referring to FIG. 3, each PE router 308 (i.e., physical router) comprises at least one access module 330 and an aggregation module 340. For example, PE router 308, illustratively comprises access modules 330₁₁ and 330₁₂ and aggregation module 340₁. PE router 308₂ illustratively comprises access modules 330₂₁ and 330₂₂ and aggregation module 340₂, and so forth. It is noted that the number of access modules 330 provided in any given router 308 is dependent on the network topology of the VPN, as discussed below in further detail. However, each physical router 308 comprises only a single aggregation module 340.

The access modules 330 are assigned to one or more VPNs and are connected to customer routers at the customer sites. Each access module 330 is dedicated to a single VPN, however a single VPN may include multiple access modules 330. Each access module can support a plurality of customer sites of the same VPN. All the access modules 330 in each router 308 are connected to the respective aggregation module 340. Each aggregation module 340 is connected to other aggregation modules 340 residing in other routers 308 through the core network 302 via MPLS label switched paths (LSPs).

In particular, the aggregation modules 340 are directly connected to each other via LSP links. Each pair of aggregation modules (e.g., 340₁ and 340₂ of FIG. 3) may be connected via multiple LSPs, where each LSP offers a different grade of service. Each aggregation module 340 is assigned an IP address from the service provider's IP address space.

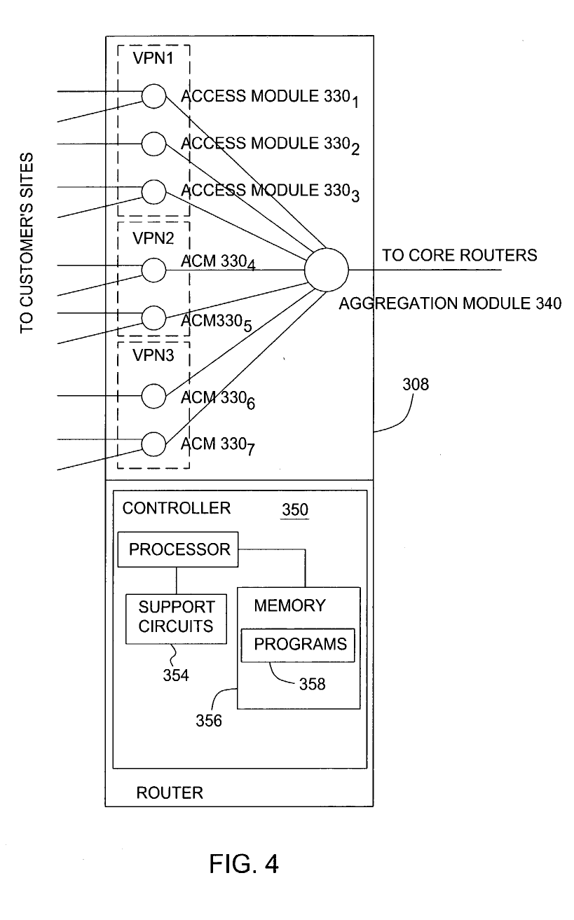

FIG. 4 depicts a block diagram of an exemplary router of the present invention suitable for use in the exemplary network of FIG. 3. The router 308 illustratively comprises a plurality of access modules 330 supporting three VPNs: VPN 1, VPN 2, and VPN 3. Access modules 330₁, 330₂, and 330₃ are dedicated to support VPN 1. Similarly, access modules 330₄ and 330₅ are dedicated to support VPN 2, while access modules 330₆ and 330₇ are dedicated to support VPN 3. Customer sites from VPN 1, VPN 2, and VPN 3 are connected to these access modules 330 from their respective customer edge routers (not shown) at the customer sites. The seven illustrative access modules 330₁ through 330₇ are all connected to the aggregation module 340, which is coupled to other aggregation modules 340 via the P-routers (not shown) of the core network 302.

The PE routers 308 are fully connected through a core network via MPLS tunnels as specified in the 2547 specification, although other tunneling technologies may also be utilized, such as IP security, IP-over-IP, and the like. The PE routers 308 converse with each other, exchanging information regarding the VPNs using Border Gateway protocol with Multi-Protocol extensions (MP-BGP), as specified under RFC 2858 by the IETF (Internet Engineering Task Force), which is incorporated by reference herein, in its entirety.

Specifically, through the routing protocol (MP-BGP), a PE 308 advertises its routes to other PEs with many other parameters, one of which is the Route Target (RT). The RT is used to describe the VPN (or VPN component) that the route is applicable to. Since a customer site may belong to multiple VPNs or VPN components, multiple RTs can be associated with a single route. Once a PE router 308 receives route advertisements from its peers, the receiving PE router 308 determines whether the route should be added to the VPN routing-forwarding (VRF) table based on the RTs. If the PE 308 is authorized to transmit for that particular RT, then the route is added to the VRF table.

Under RFC 2547, a service provider administrator separately and manually assigns the RDs and RT import and export statements. The service provider administrator needs to ensure consistent assignment to thereby ensure proper operation. For a better understanding of assigning RT statements, the reader is directed to patent application serial number 10/252,815, filed Sep. 24, 2002, entitled “Methods and Devices for Configuring Virtual Private Networks”, by Chu et al. of Lucent Technologies Inc. of Murray Hill, N.J., which is incorporated by reference herein in its entirety.

By contrast, and as discussed below in further detail, the access modules 330 of the present embodiment are determined automatically by the RTs import and export statements of the sites 320. This simplifies operations and also guarantees consistency. In other words, under the architecture of the present invention, an access module 330 is a generalized version of the VRF table under RFC 2547, and the RDs are utilized secondary to RTs. Furthermore, the access modules (routing tables) 330 are constructed based on RTs, as opposed to the routing tables being constructed by the RDs as provided under the RFC 2547 specification.

The router 308 further comprises a controller 350, which is suitable for use in the implementation of the present invention. Specifically, the controller 350 comprises a processor 352 as well as memory 356 for storing various control programs 358. The processor 352 cooperates with conventional support circuitry 354 such as power supplies, clock circuits, cache memory and the like as well as circuits that assist in executing the software routines stored in the memory 356. As such, it is contemplated that some of the process steps discussed herein as software processes may be implemented within hardware, for example as circuitry that cooperates with the processor 352 to perform various steps.

Although the controller 350 of FIG. 2 is depicted as a general-purpose computer that is programmed to perform various control functions in accordance with the present invention, the invention can be implemented in hardware as; for example, an application specific integrated circuit (ASIC). As such, it is intended that the processes described herein, be broadly interpreted as being equivalently performed by software, hardware, or a combination thereof.

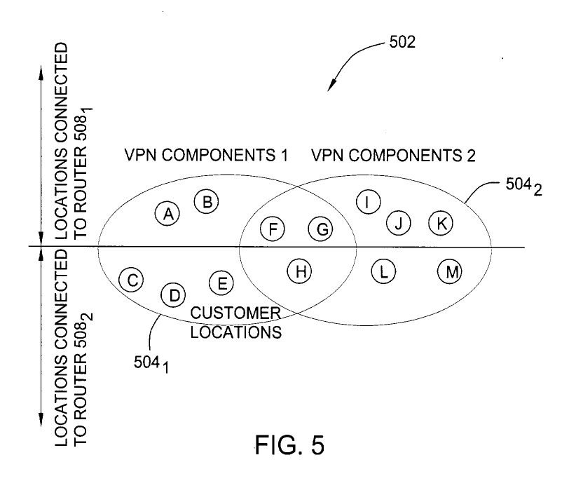

FIG. 5 depicts a schematic diagram of an exemplary VPN network 500 having two full VPN components. In particular, an exemplary customer VPN 502 including thirteen (13) sites (A to M) 520 comprises two full mesh VPN components 504₁ and 504₂. VPN component 1 504₁ includes sites A through H, while VPN component 2 504₂ includes of sites F through M. It is noted that sites F, G, and H are in both VPN components 504₁ and 504₂. Each site illustratively has an associated CE router (not shown).

Sites in VPN component 1 504₁ can converse with each other, and similarly sites in VPN component 2 504₂ can converse with each other. Further, sites F, G, and H can converse with all other sites by virtue of being members of both VPN components 504₁ and 504₂. On the other hand, sites A-E, which are only in VPN component 1 504₁ cannot send or receive packets from any of the sites I-K, which are only in VPN component 2 504₂, and vise versa.

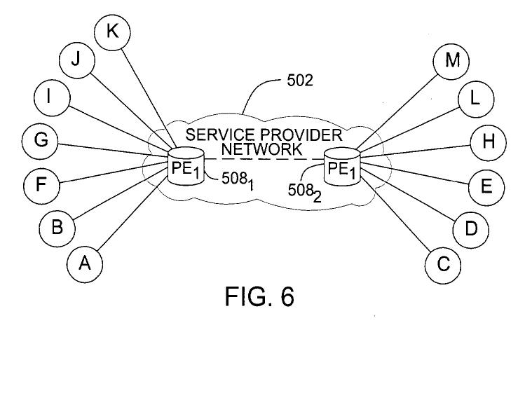

FIG. 6 depicts a schematic diagram illustrating physical connectivity of the network of FIG. 5. In particular, PE routers 508₁ and 508₂ are interconnected via a core network of core routers (not shown) in the service provider network 502. Sites A, B, F, G, and I-K are illustratively connected to PE router 508₁, while sites C-E, H, L, and M are illustratively connected to PE router 508₂. As all the sites belong to the same VPN, they all use the same IP address space. The IP address associated with site A is subnet A, the IP address associated with site B is subnet B, while the IP address associated with site C is subnet C, and so forth.

A first rule for implementing the present invention provides that customer sites that import and export the same route target (RT) are connected to the same access modules (RD). Accordingly, the number of access modules required at a PE router may be determined.

For the exemplary network shown in FIGS. 5 and 6, two RTs are required. A first RT, illustratively having an assigned number RT510, is utilized for sites A through H in VPN 1, which import and export this same RT. A second RT, illustratively having an assigned number RT520, is utilized for sites F through M in VPN 2, which import and export this RT. It is further noted that sites F through H are in both VPN components 504₁ and 504₂ and import and export to both RTs, RT510 an RT520.

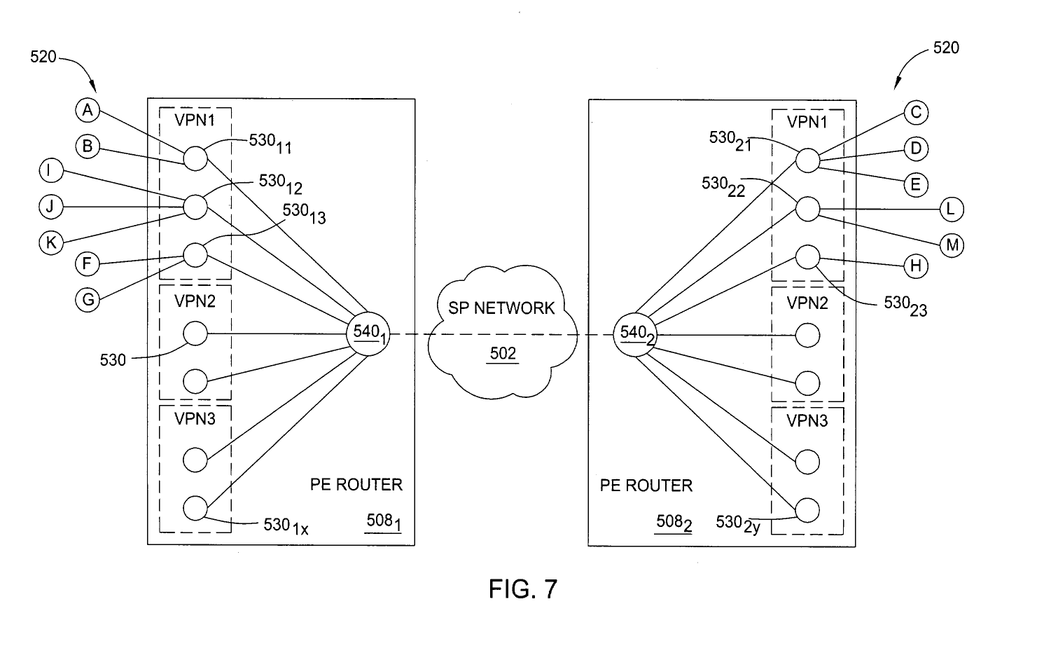

FIG. 7 depicts a high-level block diagram illustrating asset module allocation to support the VPN network 502 of FIGS. 5 and 6. Specifically, the first and second PE routers 508₁ and 508₂ each comprises an aggregation module 540₁ and 540₂ and a plurality of access modules 530₁ₓ and 530_{2y}, where x and y are integers greater than 1. The first PE router 508₁ is coupled to second PE router 508₂ by their respective aggregation modules 540₁ and 540₂ via the service provider network 502, in a similar manner as discussed above with respect to FIGS. 3 and 4.

For the illustrative RT assignment discussed above with respect to FIGS. 5 and 6, both routers 508₁ and 508₂ only need to allocate three access modules to support this VPN 504. For the first PE router 508₁, access module 530₁, is utilized to provide connectivity to customer sites A and B (those that import and export RT510); access module 530₁₂ is utilized to provide connectivity to customer sites I, J and K (those that import and export RT520); and access module 530₁₃ is utilized to provide connectivity to customer sites F and G (those that import and export both RT510 and RT520).

Similarly, for the second PE router 508₂, access module 530₂₁ is utilized to provide connectivity to customer sites C through E (those that import and export RT510); access module 530₂₂ is utilized to provide connectivity to customer sites L and M (those that import and export RT520); and access module 530₂₃ is utilized to provide connectivity to customer site H (those that import and export both RT510 and RT520).

As such, the customer sites that import the same RTs and export the same RTs are connected to the same access modules 530. This relationship allows the PE routers to determine the number of access modules required, as well as how the customer sites are connected to the access modules. It is noted that the import list and export list may be different, depending on the VPN network topology.

The RD assignment can be automatically generated. The rule according to one embodiment is as follows: for each access module, compare its import RT list with its export RT list. If they match, all the sites in that access module can be assigned the same RD. Otherwise, all the sites have different RDs.

In this example, all the access modules in each PE router each have matching import and export RT lists. Therefore, all the sites belonging to the same access module have the same RD. Accordingly, a total of three RDs are required per PE router, since there are three access modules.

Associated with each access module is a forwarding table for ingress packets, called an “ingress-forwarding table”. The ingress-forwarding table is constructed based on an RT that may be exported by the access module, which is compared to the imported RTs from the peer-to-peer router advertisements.

A second rule for implementing the present invention provides that only advertised routes with matching RTs will create entries in the ingress-forwarding table. This rule applies to routes to other routers, to other access modules within the same router, and to other interfaces (customer site) within the same access modules. Routes from other routers are acquired through the MP-BGP route advertisements for VPN. Routes from the access modules within the same router are part of the configuration information of the VPN.

In the example discussed with respect to FIGS. 5-7, the second PE router 508₂ will advertise the following routes to the first PE router 508₁ as shown below in Table 1:

TABLE 1

| IP address | | Interior |
|---|---|---|
| of Route | Associated RTs | MPLS label |
| Subnet C | RT510 | 610 |
| Subnet D | RT510 | 620 |
| Subnet E | RT510 | 630 |
| Subnet H | RT510, RT520 | 640 |
| Subnet L | RT520 | 650 |
| Subnet M | RT520 | 660 |

As discussed above, access module 530₁₁, of router 508₁ can only import RT510. Therefore, access module 530₁₁ will incorporate only advertised routes from subnets C, D, E, and H from PE router 508₂ into the ingress routing table. Thus, routes from sites L and M are excluded, since they are assigned RTs RT520. Further, router 508₁ also determines from its VPN configuration information that it can send packets to access modules 530₁₁, and 530₁₃, as both modules export RT510. Therefore, the router 508₁ will also add routes for sites A, B, F, and G to the ingress-forwarding table of access module 530₁₁. The resulting ingress-forwarding table is illustrated below in Table 2.

TABLE 2

| IP address of | | Destination | Interior MPLS |
|---|---|---|---|
| Route | Interface Type | Address/ID | Label |
| Subnet A | Self | Interface to site A | N/A |
| Subnet B | Self | Interface to site B | N/A |
| Subnet C | External | IP address of | 610 |
| Subnet D | | aggregation | 620 |
| Subnet E | | module of router | 630 |
| | | 508₂ | |
| Subnet F | Internal | Interface to site F | N/A |
| | Access module | | |
| Subnet G | 530₁₃ | Interface to site G | N/A |
| Subnet H | External | IP address of | 640 |
| | | aggregation | |
| | | module of router | |
| | | 508₂ | |

Conceptually, the ingress-forwarding table shown above corresponds to the VRF table in RFC 2547, but includes improvements that will be described in further detail below. It is noted that the interior MPLS labels shown in Tables 1 and 2 have exemplary interior MPLS label identifiers 610-640, which are provided for forwarding the packets to the egress PE router. It is further noted that a similar analysis may be performed for the routs advertised by the first PE router 508₁ to the second PE router 508₂.

A third rule for implementing the present invention highlights a difference between the ingress-forwarding table of the present invention and the VRF instance of RFC 2547, and further illustrates that the present invention is more efficient than the current architecture under RFC 2547. In particular, rule 3 of the present invention provides that the ingress-forwarding table is constructed based solely on comparing the export RT of the access modules with the import RT of the advertisements. Therefore, in the case of locations (customer sites) connecting to the same access module, connectivity between these sites are determined by comparing the import and export list of the access module. If there is no commonality between the two lists, the access module will not allow communications between the locations connecting to the access module.

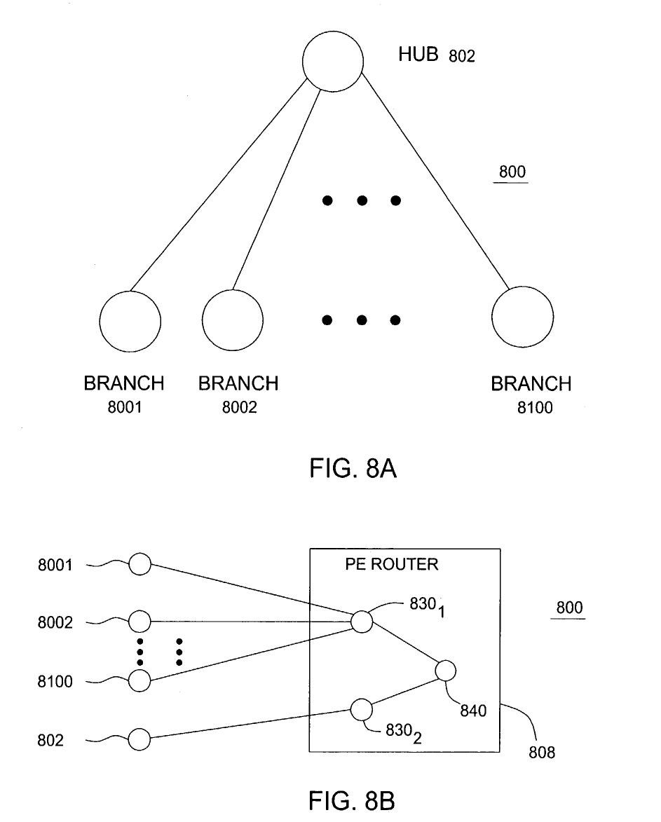

This third rule distinguishes the present invention from RFC 2547. In RFC 2547, each site is assigned a VPN Routing/Forwarding (VRF) table through the RD assignments. If two sites are assigned to the same VRF table, they automatically can send packets to each. However, this may be undesirable in some VPN configuration. Under the RFC 2547 architecture, this is handled by assigning a different VRF to each site, thereby requiring more resources, which is less efficient. The difference between the RFC 2547 architecture and the architecture of the present invention is illustrated below with respect to FIG. 8.

FIGS. 8A and 8B depict a schematic diagram of an exemplary hub-and-spoke network 800 and connectivity under the present invention. The network 800 comprises a hub site 802, and 100 branch sites 8001 through 8100. The hub 802 can converse with all the branches and vice versa. However, the branches can only converse with each other through the hub 802. Under the RFC 2547 environment, an efficient RT assignment for this network requires two RTs. The hub 802 will illustratively import RT “810” and illustratively export RT “820”, while the branches would import RT 820 and export RT 810. It is noted that the branches and hub are assigned different import and export RTs so that the branches do not communicate with each other. By contrast, if all of the branches and the hub were assigned the same import and export RT values (e.g., RT810), then the branches would be able to communicate with each other as a mesh network illustratively discussed above, rather than a hub-and-spoke network.

As the branches cannot communicate with each other directly, all branches need to have their own individual VRF table (and its own RD). The hub 802, being different from the branches, also requires its own VRF table (and RD). It is noted that in the case where all the sites are connected to a single router, such router would need to support 101 VRF tables.

Under the present invention, all the branches import and export the same RTs. FIG. 8B illustratively shows all of the branches connected to the same access module (e.g., access module 830₁), and the hub 802 is connected to a different access module (e.g., access module 830₂) of the PE router 808, as provided by rule 1. Further, the access modules 830, and 830₂ are coupled to a single aggregation module 840, as discussed above.

The ingress-forwarding table of access module 830, is constructed using rule 2, which allows all of the branches to send to the hub 802, while rule 3 prevents a branch from sending packets to another branch. Therefore, only two ingress-forwarding tables are required, one for the branches and one for the hub. Thus, the present invention is more efficient than the architecture as specified in RFC 2547, since only two tables are required, as opposed to 101 under RFC 2547. Therefore, less resources are required. Moreover, the third rule provides that an access module may be connected to sites with different RDs, since it is the RTs that serve as the defining element. Referring to FIG. 8, all the branches in a hub-and-spoke network have different RDs.

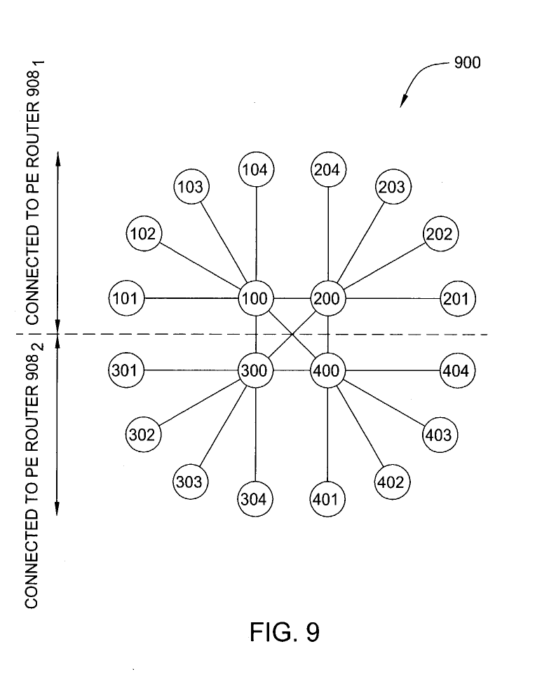

FIG. 9 depicts a schematic diagram of a second embodiment of a VPN network 900. In particular, FIG. 9 depicts a VPN network 900 comprising a fully meshed component as well as hub-and-spoke components. Specifically, the exemplary network 900 may be considered as consisting of five components. A first component comprises a core network including four (4) hub locations 100, 200, 300, and 400. The hub locations are fully connected (full mesh topology).

Connecting to hub 100 are four branches 101, 102, 103 and 104, forming a tree (or hub-and-spoke) network. Similarly, connecting to hub 200 are four branches 201, 202, 203 and 204, forming a tree (or hub-and-spoke) network. Connecting to hub 300 are four branches 301, 302, 303 and 304, forming a tree (or hub-and-spoke) network. Finally, connecting to hub 400 are four branches 401, 402, 403 and 404, forming a tree (or hub-and-spoke) network.

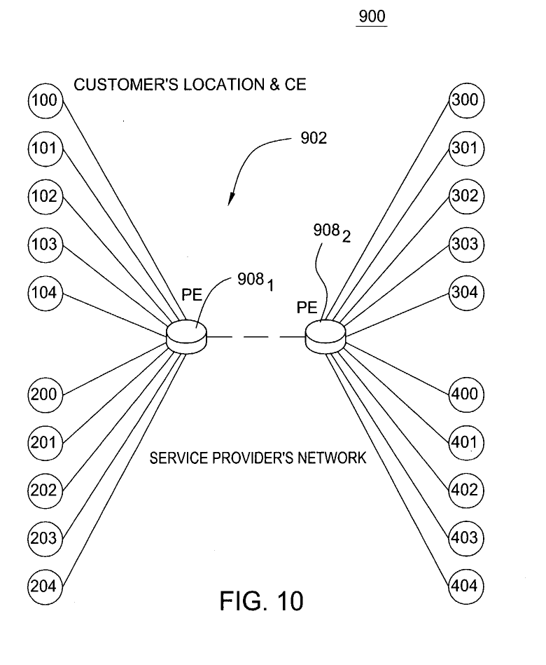

FIG. 10 depicts a schematic diagram illustrating physical connectivity of the network 900 of FIG. 9. On the physical level, sites (i.e., the CE routers at these sites) 10x and 20x are connected to PE router 908₁ in a service provider's network, while sites 30x and 40x are connected to PE router 908₂ PE router 908₁ and PE router 908₂ are coupled via the service provider network 902 in a similar manner as discussed above with respect to FIGS. 5-7.

For the network topology of FIGS. 9 and 10, all the sites 10x, 20x, 30x, and 40x are assigned their own RD, resulting in twenty (20) RD assignments. In particular, all the hubs 100, 200, 300, and 400 are different as they communicate with different respective branches 10x, 20x, 30x, and 40x. Therefore, the hubs 100, 200, 300, and 400 all have different virtual routing/forwarding (VRF) tables (and thus different RDs).

The branches also require different RD assignments. According to the RFC 2547 specification, if the branches have the same RD, the branches would be able to communicate with each other directly when connected to the same PE. However, the illustrative hub-and-spoke network topology shown in FIGS. 9 and 10 specifically prohibits this, since the branches (10x, 20x, 30x, and 40x) cannot communicate with each other. Therefore, a different RD is needed for each branch, and accordingly, a different RD is required for each site. For a detailed understanding for optimal RD (and RT) assignment, the reader is directed to patent application serial number 10/252,796, filed Sep. 24, 2002, entitled “Method and Systems for Efficiently Configuring IP Based Virtual Private Networks “by, Chu et al. of Lucent Technologies, Inc., which is incorporated by reference herein in its entirety.

Additionally, a total of nine (9) RTs are required for the network 900. A first RT is required for the full mesh network component between the hubs. This first RT is illustratively assigned a value “RT960”. For each of the four (4) tree network components (hub-and-spoke sub-networks), two (2) RTs are required, one for the upstream direction and one for downstream direction. For example, RT identifier “RT910” is assigned for the upstream direction of the 10x tree network, while RT identifier “RT911” is assigned for the downstream direction of the same tree network. It is noted that the term “upstream” denotes traffic from the branches to the hub, while the term “downstream” denotes traffic from the hub to the branches.

Similarly, RT identifier RT920 is assigned for the upstream direction of the 20x tree network, while RT identifier RT921 is assigned for the downstream direction of the same tree network. Likewise, RT identifier RT630 is assigned for the upstream direction of the 30x tree network, while RT identifier RT631 is assigned for the downstream direction of the same tree network. Finally, RT identifier RT940 is assigned for the upstream direction of the 40x tree network, while RT identifier RT941 is assigned for the downstream direction of the same tree network. The RT import and export statement for the sites at the PE routers are summarized below in Table 3.

TABLE 3

| Site | RTs imported | RTs exported |
|---|---|---|
| 100 | 960, 910 | 960, 911 |
| 200 | 960, 920 | 960, 921 |
| 300 | 960, 930 | 960, 931 |
| 400 | 960, 940 | 960, 941 |
| 101, 102, 103, 104 | 911 | 910 |
| 201, 202, 203, 204 | 921 | 920 |
| 301, 302, 303, 304 | 931 | 930 |
| 401, 402, 403, 404 | 941 | 940 |

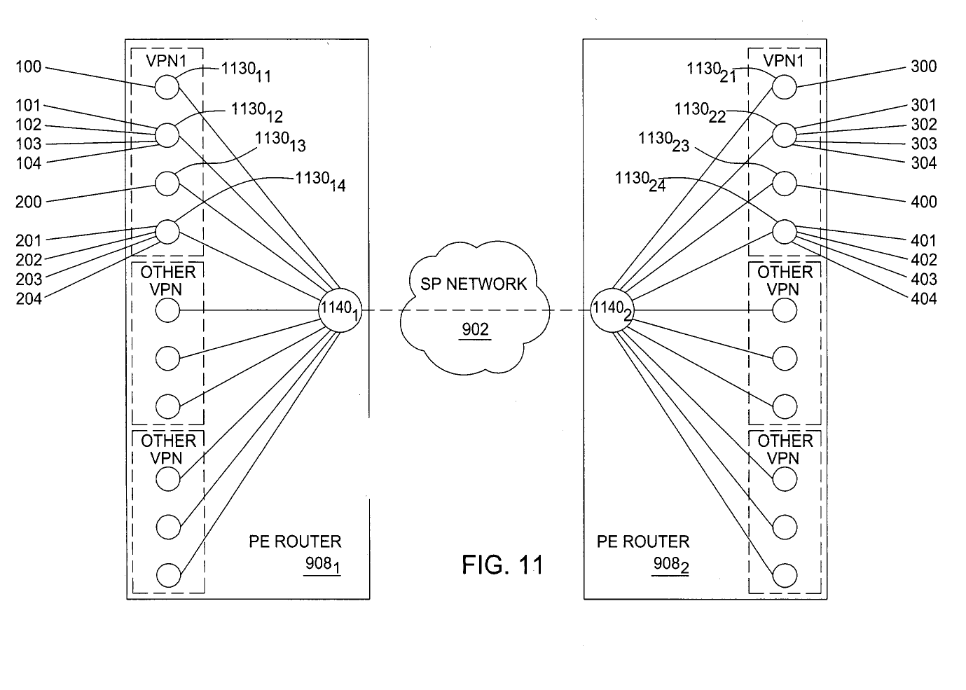

FIG. 11 depicts a high-level block diagram illustrating asset module allocation to support the VPN network of FIGS. 9 and 10. FIG. 11 is similar to the exemplary block diagram of FIG. 7, except the number of access modules and sites connected to these access modules differ due to the network topology differences therebetween. According to rule 1 (i.e., customer sites that import and export the same route target (RT) are connected to the same access modules (RD)), a total of 8 access modules are required. Sites 100, 200, 300, and 400 are each connected to a respective access module. Sites 101, 102, 103, and 104 can be connected to the same access module. Similarly, sites 201, 202, 203, and 204 can be connected to same access module. Further, sites 301, 302, 303, and 304 can be connected to same access module, while sites 401, 402, 403, and 404 can be connected to same access module.

Referring to FIG. 11, PE router 908₁ comprises access modules 1130₁ through 1130₁₄, where location 100 is connected to access module 1130₁₁, sites 101 through 104 are connected to access module 1130₁₂, location 200 is connected to access module 1130₁₃, and locations 201 through 204 are connected to access module 1130₁₄.

Similarly, PE router 908₂ comprises access modules 1130₂₁ through 1130₂₄, where location 300 is connected to access module 1130₂₁, locations 301 through 304 are connected to access module 1130₃₂, location 400 is connected to access module 1130₂₃, and locations 401 through 404 are connected to access module 1130₂₄.

The access modules 1130₁₁ through 1130₁₄ of the PE router 908₁ are each coupled to an aggregation module 1140₁, while the access modules 1130₂₁ through 1130₂₄ of the PE router 908₂ are each coupled to an aggregation module 1140₂. The aggregation modules 1140₁, and 1140₂ of the PE routers 908₁ and 908₂ are coupled to each other via label switched paths across the service provider network 902 as discussed above.

Each access module 1130 has a single ingress routing/forwarding table (i.e., a total of 8 routing/forwarding tables). This represents a saving of 60% in the number of routing-forwarding tables as compared to the RFC 2547 architecture, which would have required 20 VRF tables (i.e., one for each RD).

As per rule 1, the router determines the number of the access modules required, as well as how customer sites are connected to the access modules. Further, rule 2 describes how the forwarding table for ingress packets (those from customer sites) is constructed for each access module.

In particular, according to rule 2 of the present invention, associated with each access module is a forwarding table for ingress packets. Only routes with matching RTs will create entries in the table. This rule applies to routes to other routers, to other access modules within the same router, and to other interfaces (customer site) within the same access modules. Routes from other routers are acquired through the MP-BGP route advertisements for VPN. Routes from the access modules within the same router are part of the configuration information of the VPN.

In the example shown in FIGS. 9-11, consider access module 1130₁₁ in PE router 908₁. Let the IP address of site 100 be A₁₀₀, site 200 be A₂₀₀, and so forth. Router 908₂, which is the peer of router 908₁, will advertise the following routes to router 908₁, as illustratively shown below in Table 4.

TABLE 4

| IP address | Associated RTs | Interior |
|---|---|---|
| of Route | | MPLS label |
| Subnet A₃₀₀ | 960 | 9001 |
| Subnet A₄₀₀ | 960 | 9002 |
| Subnet A_{301,} | 931 | 9311 |
| Subnet A_{302,} | 931 | 9312 |
| Subnet A₃₀₃ | 931 | 9313 |
| Subnet A₃₀₄ | 931 | 9314 |
| Subnet A₄₀₁ | 941 | 9411 |
| Subnet A₄₀₂ | 941 | 9412 |
| Subnet A₄₀₃ | 941 | 9413 |
| Subnet A₄₀₄ | 941 | 9414 |

Recall that per rule 3 of the present invention, the ingress-forwarding table is constructed solely based on the import RT of the access modules. In the example shown in FIGS. 9-11, access module 1130₁₁ at PE router 908₁ can only import RT 960 and 910. Therefore, it will only incorporate routes from subnets A₃₀₀ and A₄₀₀ into the ingress-forwarding table, since these two subnets have RT 960 associated with them. The rest of the routes are ignored, as the RTs associated with them do not match with the import list. Effectively, this permits sites connected to access module to send to the hub sites 300 and 400 but none of the 30x and 40x branches.

Internally, router 908₁ also determines from its VPN configuration information that it may send packets to access modules 1130₁₂ and 1130₁₃. Packets may be sent to module 1130₁₂ because the module 1130₁₁ exports RT 911, the same of which is imported by access module 1130₁₂. Similarly, packets may be sent to module 1130₁₃ because module 1130₁₁ exports RT 960, the same of which is imported by access module 1130₁₃ . Therefore, the router 908₁ will add routes to sites that are attached to both modules (1130₁₂ and 1130₁₃ ) to the ingress-forwarding table of access module 1130₁₁. Note that access module 1130₁₁ cannot send packets to access module 1130₁₄, since module 1130₁₄ only imports RT921, which is not exported by access module 113011. However, access module 1130₁₃ can send packets to access module 1130₁₄ , since access module 1130₁₃ exports RT921, which is also imported by access module 1130₁₄ . The resulting ingress-forwarding table is illustratively shown below in Table 5.

TABLE 5

| IP address of | | Destination | Interior MPLS |
|---|---|---|---|
| Route | Interface Type | Address/ID | Label |
| Subnet A₁₀₀ | Self | Interface to site A | N/A |
| Subnet A₃₀₀ | External | IP address of | 9001 |
| Subnet A₄₀₀ | | aggregation | 9002 |
| | | module of router | |
| | | 908₂ | |
| Subnet A₁₀₁ | Internal | Interface to access | N/A |
| | Access module | module 1130₁₂ | |
| Subnet A₁₀₂ | 1130₁₂ | Interface to site | N/A |
| | | access module | |
| | | 1130₁₂ | |
| Subnet A₁₀₂ | | Interface to site | N/A |
| | | access module | |
| | | 1130₁₂ | |
| Subnet A₁₀₂ | | Interface to site | N/A |
| | | access module | |
| | | 1130₁₂ | |
| Subnet A₂₀₀ | Internal | IP address of | N/A |
| | Access module | aggregation | |
| | 1130₁₃ | module 1130₁₃ | |

Conceptually, the ingress-forwarding table (Table 5) is similar to the VRF table in RFC 2547. However, a reduced number of entries are required in the above example, as there are less access modules 1130 than RDs as demonstrated per rule 1. It is noted that a similar analysis may be performed for the instance where the first router 908₁ advertises the peer-to-peer information to the second router 908₂. It is further noted that an MPLS label or other identifier can be used to indicate the egress interface, such as exemplary interior MPLS labels 9001 for subnet A₃₀₀, 9002 for subnet A₄₀₀, and the like as illustratively shown in Table 4.

As packets are transferred within the PE router (e.g., access module 1130₁₁ to access modules 1130₁₂ or 1130₁₃) and between the other PE routers, one aspect of the present invention is to ensure a router implementing the present invention will appear to other routers as a RFC 2547 compliant router in every respect. Accordingly, rule 4 provides that for an ingress packet from a customer site, if the ingress-forwarding table indicates that the packet should be,forwarded to another device, the access module passes the packet to the aggregation module, together with the following information: (a) the IP address of the destination aggregation module and (2) the interior MPLS label to be used.

Based on the IP address of the destination aggregation module and the grade of service of the particular VPN, the local aggregation module selects the appropriate MPLS Label Switched Path (LSP) to use. The aggregation module formats the resulting MPLS frame in a similar manner as provided under RFC 2547, and then sends the formatted MPLS frame to the destination aggregation module using an exterior label.

Logically, the aggregation modules maintain an MPLS-LSP forwarding table as shown in Table 6.

TABLE 6

| Destination | | Exterior |
|---|---|---|
| IP Address | Grade of Service | LSP Label |
| Subnet A | Gold | 2000 |
| | Silver | 2001 |
| | Copper | 2002 |
| Subnet B | Gold | 2003 |
| | Silver | 2003 |
| | Copper | 2004 |
| Subnet X | . | . |
| | . | . |
| | . | . |

Table 6 identifies various grades of service for each destination IP address. The grades of service are quality of service (QoS) levels, which illustratively include constant bit rate (CBR), variable bit rate (VBR), real-time variable bit rate (VBR-rt), controlled load, guarantee service, best effort services, among other services known in the industry. Each grade of service for each destination IP address is provided with an exterior LSP label. In lieu of the exterior LSP, other tunneling technology such as IP sec can be used. Upon receipt of a MPLS frame from a peer ingress PE router, the egress PE router examines the interior MPLS label to determine the egress interface.

The purpose of the aggregation module is to process all the functions that are related to the transfer (forwarding) of packets across the network and within the router for all the access modules. The access modules and aggregation module in each PE router are illustratively shown as being logically independent modules. However, a person skilled in the art will appreciate that in an alternate embodiment of the invention, the aggregation functionality may be incorporated into each access module. This avoids an additional module (i.e., aggregation module) in the PE router, but at the expense that each access module would be more complex. It is further noted that variations of these two embodiments are possible.

Specifically, during normal operation, each interface to a customer site is assigned a unique interior label. However, it is also possible to associate an egress-forwarding table with the interior MPLS label. For example, the interior MPLS label may point to an access module. The destination IP address of the incoming packet is used to determine the egress interface.

One benefit of the present invention is that the ingress-forwarding table can be common to more than a single customer site. This reduces the number of forwarding tables, thereby improving the performance and reducing the cost of the router. Another benefit is that the determination of the access modules is automated based on RT assignments, as opposed to 2547 specifications, where the RD and RT are assigned manually and separately. Accordingly, by decomposing the PE routers into various software modules, the PE routers are able to support RFC 2547 features in a more efficient manner by reducing the number of routing tables with in the router.

Thus far, the present invention has been described at the router level, i.e. the necessary logic at a PE router. However, the present invention also operates at the network level.

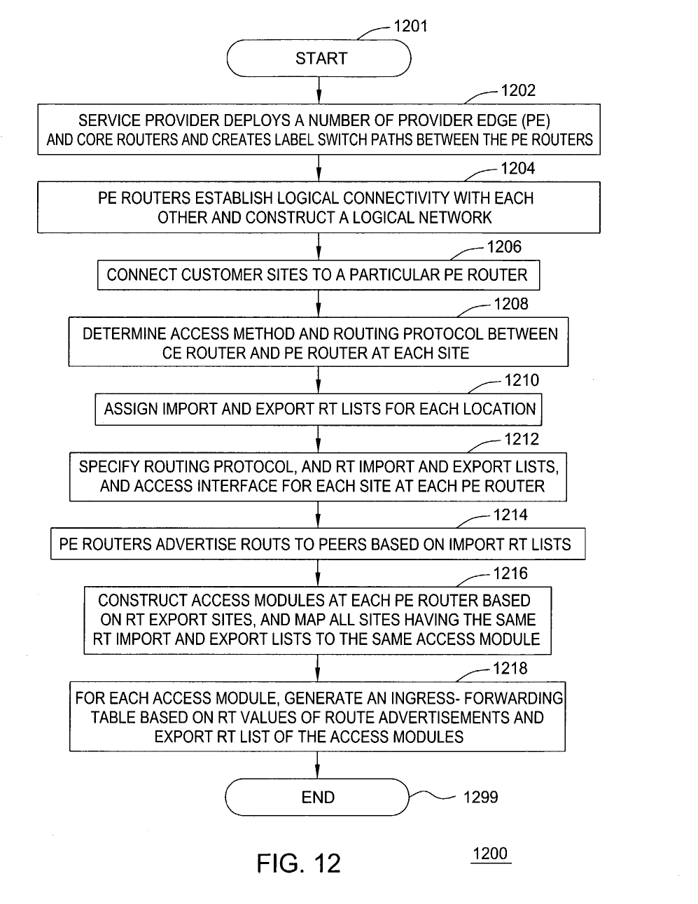

FIG. 12 depicts a flow diagram of a method 1200 of implementing the VPN of the present invention. The method 1200 starts at step 1201, and proceeds to step 1202, where a service provider deploys a number of core and PE routers. The service provider connects all the PE routers pairwise through MPLS label switched paths (LSP). Separate LSPs are required for each class of the service that the service provider would like to provide. Multiple LSPs may be set up to support the same class of service to provide additional functions, such as diverse routing. It is noted that other tunneling technologies, such as IPsec (IP with Security) may be used in lieu of MPLS. For each PE router, the service provider inputs a list of its peer PE routers via a network manager or other external means. Through this list, a PE router may subsequently establish BGP associations with its peers to exchange VPN information, such as route advertisement.

At step 1204, the PE routers establish logical connectivity with each other, and construct a logical network. Thus, steps 1202 and 1203 are used to construct a physical network.

At step 1206, the customer sites associated with the VPNs are connected to a particular PE router. Specifically, a customer subscribing to the VPN service, informs the service provider of all the customer sites (locations) in the VPN as well as the desired logical topology. Such topology may be a full mesh, partial mesh, hub-and-spoke, star, and the like, or a combination thereof. The SP determines for each location, the PE router that the location should connect to, based on locality of the customer sites.

The following steps 1208 through 1218 add locations (i.e., customer sites) to the VPNs. In particular, at step 1208 the customer and the SP then specify, for each location, the access method (e.g. frame relay, ATM, PPP) used. The routing protocol between the CE and PE router (e.g. BGP, RIP, static, etc.) for the location is also specified. As such, the PE router is able to learn about the routes.

At step 1210, the SP assigns the import and export RT lists for each location, based on the desired network topology, and at step 1212 the SP specifies at the PE routers, for each site, the access interface, the routing protocol, and the RT import and export lists.

At step 1214, the PE routers advertise the routes of the VPN to its peers based on the import RT lists. It is noted that the PE router automatically assigns an interior MPLS label, which is associated with a route.

At step 1216 the PE router constructs access modules based on the RT export lists of the locations as described above. That is, all locations with the same RT import and RT export lists are mapped to the same access modules. Customer sites are also connected to the appropriate access modules.

At step 1218 for each access module, the PE router constructs an ingress-forwarding table based on the RT values of the route advertisement, as well as the export RT list of the access modules. Once the ingress-forwarding table is constructed for all the access modules of a VPN, the VPN is established and capable of transferring information. The method 1200 then proceeds to step 1299, where the method 1200 ends.

During the life cycle of a VPN, the VPN may need to be modified. Accordingly, the present invention provides a technique for modifying a VPN network.

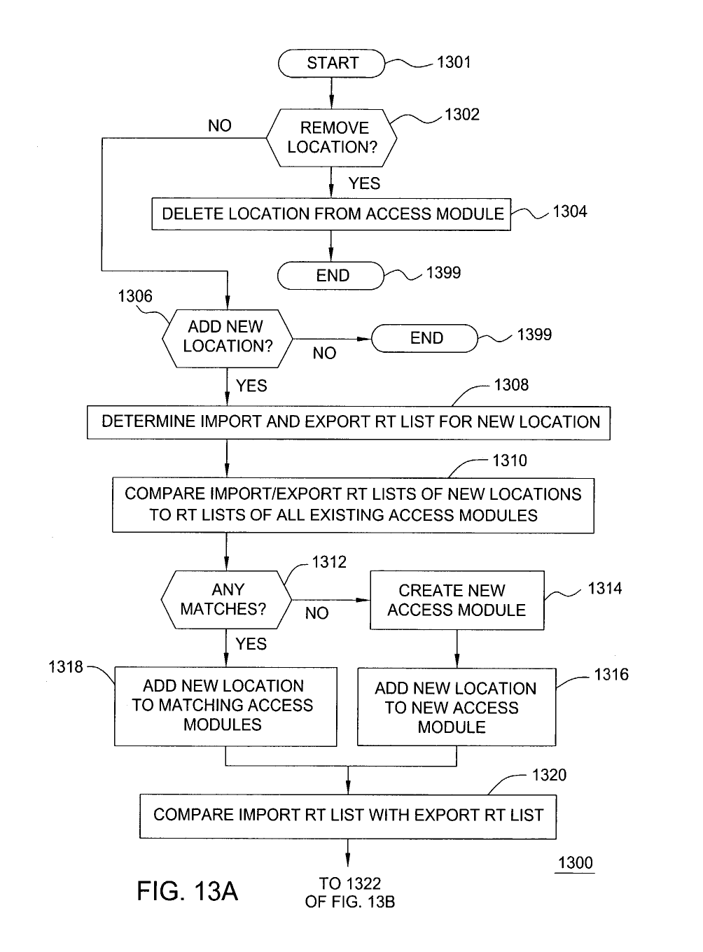

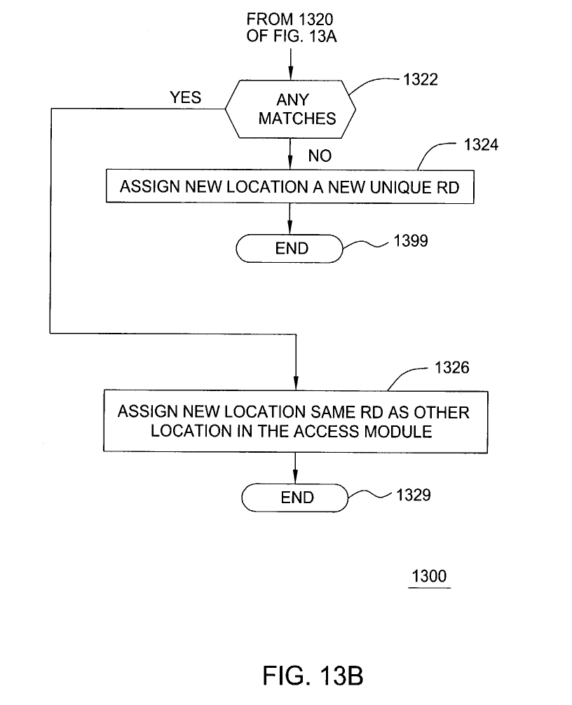

FIGS. 13A and 13B together depict a flow diagram of a method 1300 of modifying sites in a VPN network. In particular, method 1300 provides a process for adding, removing, and/or moving customer sites in a VPN network. The method 1300 starts at step 1301 and proceeds to step 1302, where a determination is made to modify the sites in the VPN network. If at step 1302, a site is to be removed, then at step 1304, the site to be removed is deleted from the respective access module and the method 1300 ends at step 1399.

If at step 1302, a site is not to be removed from the VPN network, then the method 1300 proceeds to step 1306, where a determination is made whether a new site is to be added to the VPN network. If a new site is not to be added to the VPN network, the method 1300 ends at step 1399. Otherwise, the method proceeds to step 1308.

At step 1308, the method determines the import and export RT list for the new site. The RT is assigned based on the desired connectivity of the site.

At step 1310, the router compares the import and export RT lists of the site to the RT lists of all existing access modules. Specifically, all sites connected to the same access modules will have the same import and export RTs lists (by rule 1 discussed above). These two lists are referred as the RT-list of the access module. If at step 1312, there is a match, then the method 1300 proceeds to step 1318, where the new site is added as a member of the matching access modules. The method then proceeds to step 1320, which is discussed below in further detail.

If at step 1312 there is not a match, then the method 1300 proceeds to step 1314. At step 1314, the router creates a new access module, and at step 1316, the new site is assigned to the newly created access module. The method 1300 then proceeds to step 1320.

At step 1320, the import RT list is compared with the export list of the new site. If at step 1322, the import RT list does not match with the export list of the new site, then at step 1324, the new site will be assigned a new unique RD. The method 1300 then proceeds to step 1399, where the method 1300 ends. If at step 1322, the import RT list matches with the export list of the new site, then at step 1326, the new site would be assigned the same RD as the other sites belonging to the same access modules. The method 1300 then proceeds to step 1299, where the method 1200 ends.

It is noted that there may be instances where it is desirable to move a site. In particular, if the topology of the VPN changes, the affected locations may have new RT import and exports. In such instances, method 1300 may be implemented by first removing a site from the VPN, as discussed above with respect to steps 1302 and 1304, and then modifying the RT import and export lists of the site. The new site is then added into the VPN, as discussed above with respect to steps 1306 through 1326.

It is further noted that optimal RD assignment is automatic when implementing the present invention. The service provider just needs to determine the import and export RT lists of a site. RD assignment (whether an old RD can be used or a new one is needed) is automatic. Conversely, under RFC 2547, the service provider has to determine both the RT import and export lists, as well as the RD assignment. Therefore, saving in operations is realized.

Although various embodiments that incorporate the teachings of the present invention have been shown and described in detail herein, those skilled in the art can readily devise many other varied embodiments that still incorporate these teachings.

What is claimed is:

1. In a service provider (SP) network comprising a plurality of provider edge (PE) routers and customer sites each having a respective customer edge (CE) router, a method for providing virtual private network (VPN) connectivity between at least two customer sites, comprising:
automatically generating at least one access module for each PE router associated with a VPN, such that customer sites that are associated with said VPN and have an identical export route target (RT) value and import RT value, are connected to a common access module;
generating an ingress-forwarding table for each access module; and
routing packetized information between said at least two customer sites via at least one label switched path.

2. The method of claim 1, wherein said automatically generating said at least one access module at each PE router further comprises connecting customer sites, which are associated with said VPN without having identical export and import RT values, to their own respective access modules.

3. The method of claim 1, wherein prior to automatically generating said at least one access module, said method further comprises:
specifying a routing protocol, route target (RT) import and export lists, an IP address respectively associated with each VPN route, and access interfaces for each said customer site; andadvertising VPN routes between peer PE routers.

4. The method of claim 3, wherein each said import and export RT lists respectively comprises import and export RT values, wherein said specified import RT lists and export RT lists are based on a desired network topology.

5. The method of claim 4, wherein said advertising step further comprises distributing routes between said peer PE routers using border gateway protocol with multi-protocol extension (BGP-MP).

6. The method of claim 1, wherein said generating said ingress-forwarding table for each access module comprises comparing received RT values from route advertisements to said export RT list of said access module.

7. The method of claim 6 further comprising, in an instance where any advertised RT values from an RT import list of an access module of a peer PE router having an identical RT value to any RT values in the export RT list associated with said access module, an entry is created in said ingress-forwarding table of the access module.

8. The method of claim 6, wherein an entry in said ingress-forwarding table comprises:
an IP address associated with a destination advertising a route;
an interior MPLS label from said route advertisement
an exterior MPLS label determined from said IP address of said destination advertising the route; and
a grade of service of said VPN.

9. The method of claim 6 further comprising, in an instance where any RT values in an import list of an access module of have an identical RT value to any RT values in an export RT list of said common access module, an entry is created in said ingress-forwarding table of the common access module, thereby allowing said customer sites connecting to said common access module to send packets to each other.

10. The method of claim 6 further comprising, in an instance where any RT values from an RT import list of a first access module of a PE router have any identical RT values to any RT values in an export RT list associated with a second access module in said PE router, an entry is created in said ingress-forwarding table of said second access module, thereby allowing packets to be sent to said first access module.

11. The method of claim 5, wherein customer sites belonging to the same access module are assigned a common route distinguisher (RD) in an instance where the import RT list matches the export RT list; and
otherwise, assigning different route distinguishers in an instance where the import RT list and the export RT list differ.

12. The method of claim 4, wherein in an instance said network topology changes, said method further comprises:
removing a site from said VPN;
modifying the import RT and export RT lists of said site; and
in an instance where it is desirable to add a new customer site to said VPN, adding said new customer site to said VPN.

13. A provider edge (PE) router comprising:
at least one access module adapted for connectivity to at least one customer site in a VPN, wherein customer sites associated with a particular VPN having any identical export route target (RT) values and import RT values are connected to a common access module; and
customer sites associated with said PE router that do not have identical export and import RT values are coupled to their own respective access modules at said PE router.

14. The router of claim 13, further comprising an aggregation module connected to each of said at least one access modules, wherein said aggregation module is adapted for providing connectivity between at least two access modules in a common PE router.

15. The route of claim 14, wherein said aggregation module is adapted for providing connectivity between peer PE routers in said VPN.

16. The router of claim 13, wherein said PE router complies with Internet Engineering Task Force Request For Comments (IETF-RFC) specification 2547 for providing virtual VPN services.

17. The router of claim 13, wherein said PE router communicates with other PE routers using a VPN routing protocol to exchange VPV information.

18. The router of claim 17, wherein the VPN routing protocol comprises Border Gateway Protocol with Multi-Protocol extension (MP-BGP).

19. The router of claim 13, wherein customer sites, which are associated with said VPN and have an identical export route target (RT) value and import RT value, are connected to a common access module.

20. The router of claim 19, wherein customer sites, which are associated with said VPN without having identical export and import RT values, are connected to their own respective access modules.

21. The router of claim 13, wherein each access module comprises an ingress-forwarding table for routing incoming packets.

22. The router of claim 21, wherein said ingress-forwarding table is constructed automatically by said PE router based on route information from at least one of peer routers in the network and other access modules generated in said PE router.

23. The router of claim 22, wherein said ingress-forwarding table comprises:
an ingress-forwarding table entry, in an instance where said access module can import a route target associated with a route.

24. The router of claim 23, wherein each said ingress-forwarding table entry comprises:
an internet protocol (IP) address of a route;
a type of the connection to one of a peer PE router, another access module in the same router, and a different site associated with said access module;
an identifier of an egress device; and
an interior MPLS label associated with the route.

25. In a service provider (SP) network comprising a plurality of provider edge (PE) routers and customer sites each having a respective customer edge (CE) router, an apparatus for providing virtual private network (VPN) connectivity between at least two customer sites, comprising:
means for automatically generating at least one access module for each PE router associated with a VPN, such that customer sites that are associated with said VPN and have an identical export route target (RT) value and import RT value, are connected to a common access module;
means for generating an ingress-forwarding table for each access module; and
means for routing packetized information between said at least two customer sites via at least one label switched path.
